(19) United States
(12) Patent Application Publication
(10) Pub. No.: US 2010/0065208 A1
(43) Pub. Date: Mar. 18, 2010

(54) Method using device for easy pick up of small objects

(76) Inventor: Amy Claire Roszak, Poulsbo, WA (US)

Correspondence Address: Amy C. Roszak, 16061 Cassie Pl. NW, Poulsbo, WA, 98370, US

(21) Appl. No.: 12/584,035

(22) Filed: Aug. 31, 2009

Related U.S. Application Data
(60) Provisional application No. 61/191,992, filed on Sep. 15, 2008.

(51) Int. Cl. B32B 37/00

(52) U.S. Cl. 156/308.2; 156/538

(57) ABSTRACT

A method for picking up small objects using a pliable, tacky composition whereby after the composition is touched to a small object so that the object temporarily adheres to it, the object can be manually removed or transferred from the composition. The tacky composition may be used with an apparatus.

This application claims the benefit of provisional patent application Ser. No. 61/191,992 filed on Sep. 15, 2008.

### FIELD OF THE INVENTION

The present invention relates to hand tools, and more specifically, it is directed towards a hand tool with a tacky composition to make it easy to pick up and place small objects.

### BACKGROUND OF THE INVENTION

This invention relates to a several different fields of application including, but not limited to, crafts, fingernail art, pharmaceutical, and industrial-home workshops. In each situation, an object needs to be picked up which is difficult both because the object is small and challenging to grasp or place, or because of user imitations for example those caused by arthritis or compromised vision.

In crafts such as scrap booking, card making, sewing, bead works, clay working, apparel or shoe adornment, and egg decoration, tiny embellishments, including but not limited to gems, sequins, punched shapes, and buttons, are placed onto an adhesive, strung, pressed into clay, or objects such sewing pins that have scattered need to be picked up. Tweezers and fingers are the most common implements used to pick up and place these tiny objects, however, serious limitations are encountered in the form of imprecise placement using fingers and objects getting bent, crumpled, or shooting out of the grips of tweezers.

Nail artists place ultra small jewels and decorations onto wet nail polish. Tweezers, or a brush dipped in wet polish, are the most common implements used to pick up and place these small jewels. Difficulty with current methods includes the jewels shooting out from the grip of the tweezers and transferring from the equally tacky polish on the brush to the fingernail polish.

In the pharmaceutical/dental/medical arena, small pills or appliances can be challenging to pick up due to the object's size or because of user limitations such as with dexterity or eyesight.

In workshop applications, washers, screws, and the like can be difficult to grasp and place into a proper location. Those skilled in the field know that while many tools are available with magnetic tips, non-steel items will not stick to a magnet, and many tools do not have a magnetic tip.

One embodiment of the prior art device taught in Dalbo U.S. Pat. No. 5,251,943 calls for a kit which would include a bottle of “pressure sensitive adhesive” which would be applied to an elongated member. This invention is directed only towards the picking up of tiny craft beads. In beading, release is irrelevant as a needle completes the transfer. Disadvantages of this invention to other uses include an 1) inherent delay time required for drying the liquid adhesive, 2) limitations of size, weight and shape of objects as pressure sensitive adhesive can not securely hold chunky, irregular objects, 3) unattractive and contaminated layers of adhesive on the elongated member from repeated applications, and 4) difficult transfer of an embellishment onto another adhesive or onto wet nail polish from the high-tack pressure sensitive adhesive on the elongated member.

There is clearly a need which would allow the nail artist to seamlessly pick up and transfer tiny gems to wet nail polish, paper crafters to pick up and precisely place embellishments onto a project, arthritic fingers to easily pick up pills and small items, screws to be held fast to a screw driver, and other uses involving picking up and placing small objects. The necessary product would pick up and hold fast small dimensional objects in a variety of sizes, shapes, and compositions, yet release them easily and instantly such as when setting the object onto an adhesive or sticky surface. A strong hold with instant release or transfer is essential for proper function. This need is met by the present invention, which is summarized and described below.

### BRIEF SUMMARY OF THE INVENTION

According to the principal aspect of the invention, there is provided a pliable, tacky composition, which temporarily sticks to and picks up the small items.

In a second aspect of the invention, there is provided a method for using the tacky composition.

In a third aspect of the invention, there is provided an apparatus, which may be used in conjunction with the tacky composition.

DETAILED SUMMARY OF THE INVENTION

In its broadest aspect, there is provided a quantity of pliable, tacky composition comprised of silicone or wax similar to the silicones and waxes used for orthodontic irritation relief, or a nondrying polymer clay-like product. The invention allows for multiple degrees of tackiness from “craft strength” to “industrial strength”. Craft strength requires the delicate balance of pickup and hold yet instant release or transfer. For craft purposes, the preferred material is similar to orthodontic relief silicone. For applications requiring a stronger hold and where transfer release is not a requirement, a pliable wax similar to orthodontic relief wax is the preferred material. FDA approved orthodontic silicone and relief waxes are also ideal in situations where toxicity is a concern.

The preferred embodiment of the apparatus is a thin, wooden wand with a blunt and a pointed end. The wand's diameter is quite thin to minimize interference, obstruction, or impressions, for example when pressing a gem into clay, and the length is appropriate to be easily held in the hand. Alternative embodiments of the apparatus are feasible.

Use of the composition is straightforward. In the preferred embodiment, a small piece of the composition is touched, either directly or by means of an apparatus, to an object so that the object temporarily adheres to it. The object can be manually removed from the composition or transfer of the object from the composition to an adhesive will occur when the object being held by the composition is touched to adhesive tackier than the composition. If an apparatus is to be used, the composition is presented on one end, and the other end could be used to manipulate the object after placement. The composition can be reused as long as it is effective, and replaced with a small quantity of fresh composition when necessary.

### EXAMPLES

a) Without the use of the apparatus: While unable to set a screw in a difficult location, a small amount of the composition is pressed onto the head of a screw. The screwdriver blade is pressed into the composition, enabling the screw to be held fast and easily set into this hard to reach place.

b) Using an apparatus: Crafting embellishments, consisting of wool fibers, metal eyelets, and plastic confetti is to be adhered to adhesive on a greeting card. Difficult to pick up and even more challenging to set in the precise location on the adhesive, the task is frustrating. With tweezers, the eyelets pop out of the grips, and the confetti is difficult to grasp. The composition placed on the end of the apparatus easily picks up the embellishments and instantly transfers the items to the tackier drops and lines of adhesive on the card.

The terms and expressions which have been employed in the foregoing specifications are used therein as terms of description and not of limitations, and there is no intention in the use of such terms and expressions of excluding equivalents of the features shown or portions thereof, it being recognized that the scope of the invention is defined and limited by the claims which follow.

The invention claimed is:

1. A method for picking up small objects whereby a pliable, tacky composition of silicone, wax or a nondrying polymer clay-like product is touched to a small object and the object temporarily adheres to it before being removed from it or transferred elsewhere.

2. A method whereby said tacky composition of claim 1 is used in conjunction with an apparatus.

3. A pick up device whereby a daub of said tacky composition in claim 1 is applied to said apparatus in claim 2.

4. A pickup device whereby said apparatus in claim 2 surrounds a core of the said tacky composition of claim 1.
